(19) United States
(12) Patent Application Publication
(10) Pub. No.: US 2006/0075438 A1
(43) Pub. Date: Apr. 6, 2006

(54) Device, system, and method for bridging a video signal to a high speed serial port

(76) Inventor: William E. Rehbock, Santa Clara, CA (US)

Correspondence Address: WAGNER, MURABITO & HAO LLP, Third Floor, Two North Market Street, San Jose, CA, 95113, US

(21) Appl. No.: 10/956,291

(22) Filed: Oct. 1, 2004

(51) Int. Cl. H04N 7/18

(52) U.S. Cl. 725/80; 725/74

(57) ABSTRACT

A device, system, and method for bridging a video signal to a high speed serial bus port are disclosed. The device for bridging a video signal to a high speed serial bus port has an input for accessing the video signal and a capture component, such as a video tuner, coupled thereto, for capturing the video signal. A processing component, coupled to the capture component, processes the video signal. The processing includes serializing the video signal into a serial data stream. A device output, coupled to the processing component, transmits the serial data stream to the high speed serial bus port. Thus, the device effectively captures a wide variety of video signals and encodes them for transmission on a high speed serial bus. The system is expandable, which allows simultaneous access, for effectively simultaneous processing and recording, to multiple video signals from different video sources.

### TECHNICAL FIELD

The present invention relates to the field of video signal processing. More specifically, embodiments of the present invention include a device, system, and method for bridging a video signal to a high speed serial bus port.

### BACKGROUND

Television and personal video devices such as portable video camera recorders (camcorders) and related technology, products, and services have become extremely popular and useful. It is common today to find households and enterprises with more than one television and/or source of viewing choices. For instance, many households have cable television access.

Technological advances have brought useful new television products at reasonable costs. Thus, for instance, Digital Satellite Systems (DSS) offer a wide variety of viewing selections, which increase quantity, and high definition television (HDTV) has improved the quality of what is viewed. Such systems are becoming increasingly popular and affordable. The Open Cable Standard and other industry developments have the potential to improve the quality of cable television related video products and services.

Increasingly, computers such as the personal computer (PC) and portable computers such as laptops are used to provide video related processing. With their processing, networking, data storage, video and related applications, and related other capabilities, computers are very useful in video roles. The functionality of PCs, laptops, and other computers is increased with peripheral devices. Many modern peripherals interface to the computer with a high speed serial port for efficient, rapid data exchange.

Data is exchanged between the computers' high speed serial port and their peripherals using high speed serial busses, which can support large bandwidths. Two modern and widely used useful high speed serial busses are Apple Computer's FireWire™ and high speed universal serial bus (USB). FireWire transfers data substantially in accordance with Standard 1394 of the Institute for Electronics and Electrical Engineering (IEEE), frequently and hereinafter referred to as IEEE 1394. FireWire couples to the computer with the computer's so-called ‘1394’ high speed serial port. High speed USB is sometimes referred to as USB 2.0, e.g., to distinguish it from an older, slower USB variant.

Video signals to a computer, for data storage, video processing, etc., can be transferred from broadcast tuners such as a cable TV tuner box, a DSS tuner box, a tuner box substantially compliant with the Open Cable Standard, etc., as well as camcorders, video recorders, and the like, using FireWire and/or USB 2.0.

FireWire allows connection of up to 63 devices to a computer. USB 2.0 allows even more; typically up to 127 peripherals. Both media, FireWire and USB 2.0, provide flexibility and convenience. For instance, both media allow safe hot swapping, wherein peripherals are safely coupled to and/or de-coupled from the computer while the computer and/or the peripheral are running, e.g., at rated power.

While modern computers and high speed serial busses are useful with video applications, video signals are typically provided to the computer from the broadcast tuners, camcorders, and the like. Personal video recorders (PVR) such as TiVo™ can be programmed to allow multiple video sources to be accessed, e.g., at different times, such as to record a particular video broadcast. PVRs are available as computer add-in-cards such as NVIDIA's Personal Cinema™ and ATI's All-in-Wonder™ cards.

However, users can find themselves in need of connections between the PVR and a particular tuner corresponding to the video signal they desire to record, process, or otherwise write to their computer's hard drive or other data storage. Each such tuner and PVR adds expense and weight and requires space for its deployment and complicates electrical, optical, etc., interconnections with the computer. Such weight and space demands and interconnectivity issues can be inconvenient to a user and can tend to inhibit portability. Yet many users find such portability desirable.

Further, the PVR typically records (e.g., captures) a single video signal at any given time or allows a user to view one video signal while recording another. This can be somewhat frustrating to a user with multiple video signal sources of interest all simultaneously available and desirable.

### SUMMARY

What is needed is a device to allow a user to access, for processing and recording, a variety of video signals from different video sources. What is also needed is a device to allow a user to access, for such processing and recording, various video signals from different video sources, that is convenient and does not inhibit portability. Further, what is needed is a device to allow a user to simultaneously access, for effectively simultaneous processing and recording, multiple video signals from different video sources. It is desirable that these needs be satisfied in a simple and inexpensive way.

Accordingly, a device, system, and method for bridging a video signal to a high speed serial bus port are disclosed. The device, system, and method for bridging a video signal to a high speed serial bus port disclosed herein allow a user to access, process, and record a variety of video signals and related signals (e.g., audio signals, infrared signals, etc.) from different video sources. The device, system, and method for bridging a video signal to a high speed serial bus port disclosed herein also allow a user to access, process, and record a variety of video signals from different video sources conveniently and without deterring portability.

Further, the device, system, and method for bridging a video signal to a high speed serial bus port disclosed herein also allow a user to simultaneously access, for effectively simultaneous processing and recording, multiple video signals from different video sources. The device, system, and method for bridging a video signal to a high speed serial bus port disclosed herein achieves these useful features conveniently and with low cost (e.g., relative to conventional approaches, wherein multiple tuners may be used).

In one embodiment, a device for bridging a video signal to a high speed serial port has an input for accessing the video signal and a capture component coupled thereto, for capturing the video signal. In one embodiment, the capture component comprises a video tuner. A processing component, coupled to the capture component, processes the video signal. The processing includes serializing the video signal into a serial data stream. A device output, coupled to the processing component, transmits the serial data stream to the high speed serial port. Thus, the device effectively tunes (e.g., or otherwise captures) a wide variety of video signals and encodes them for transmission on a high speed serial bus.

The high speed serial bus port can be a component of a computer or another electronic device, apparatus, system, etc. In one embodiment, the high speed serial bus port comprises a FireWire port, substantially compliant with IEEE 1394. In one embodiment, the high speed serial port comprises a high speed Universal Serial Bus (USB) port, such as one substantially functional as a USB 2.0. In one embodiment, both USB 2.0 and FireWire ports can access the serial data stream provided by the bridging component. The compressed data stream can thus be effectively coupled to a computer hard drive (HDD) or another storage system. Special encoding related to, e.g., DSS and HDTV, while not necessary to serialize the data stream for transport to the high speed serial bus port, can be performed.

The bridging device can be used with another to provide expandability, for bridging multiple video signals to the high speed serial bus port. Thus, more than one video signal can be bridged at the same time. The video signals can include a radio frequency (RF) signal, a composite video signal (CVS), or a super video signal (SVid), and can also include audio and infrared signals. Signals from a Digital Satellite System (DSS) and video signals substantially conforming to the Open Video Standard can also be bridged to the high speed serial bus port, as well as high definition television (HDTV) and digital visual interface/high definition multimedia interface (DVI/HDMI), high definition digital versatile disk (HD-DVD) and/or Blu-Ray™.

In one embodiment, the device includes a file decoder coupled to the capture and processing components, which supports standardized and other video formats, such as Motion Picture Experts Group (MPEG) files, Digital Video Express (DiVX) files, etc. In one embodiment, the file decoder handles MPEG-2 and/or MPEG-4 Files. In one embodiment, the file decoder uses Windows™ media video (WMV9™), e.g., With HD-DVD, H.263, AVC/H.264, etc. The functionality provided, e.g., with one bridging device, is expandable. In one embodiment, one bridging device can effectively be used with one or more others to provide, e.g., a multi-tuner functionality to the high speed serial port.

### BRIEF DESCRIPTION OF THE DRAWINGS

FIG. 1 depicts an exemplary device for bridging a video signal to a high speed serial port, according to an embodiment of the present invention.

FIG. 2 depicts an exemplary legacy video bridging device module, according to an embodiment of the present invention.

FIG. 3 depicts an exemplary Open Video Standard video bridging device module, according to an embodiment of the present invention.

FIG. 4 depicts an exemplary Digital Satellite System video bridging device module, according to an embodiment of the present invention.

FIG. 5 depicts an exemplary system for bridging a video signal to a high speed serial port, according to an embodiment of the present invention.

FIG. 6 depicts an exemplary expanded system for bridging a video signal to a high speed serial port, according to an embodiment of the present invention.

FIG. 7 is a flowchart of an exemplary process for bridging a video signal to a high speed serial port, according to an embodiment of the present invention.

### DETAILED DESCRIPTION

A device, system, and method for bridging a video signal to a high speed serial bus port are disclosed. Reference is now made in detail to several embodiments of the invention, examples of which are illustrated in the accompanying drawing figures. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, one of ordinary skill in the art will realize that embodiments of the present invention may be practiced without these specific details. In other instances, well-known devices, circuits, methods, processes, procedures, systems, components, and apparatus have not been described in detail so as not to unnecessarily obscure aspects of the present invention.

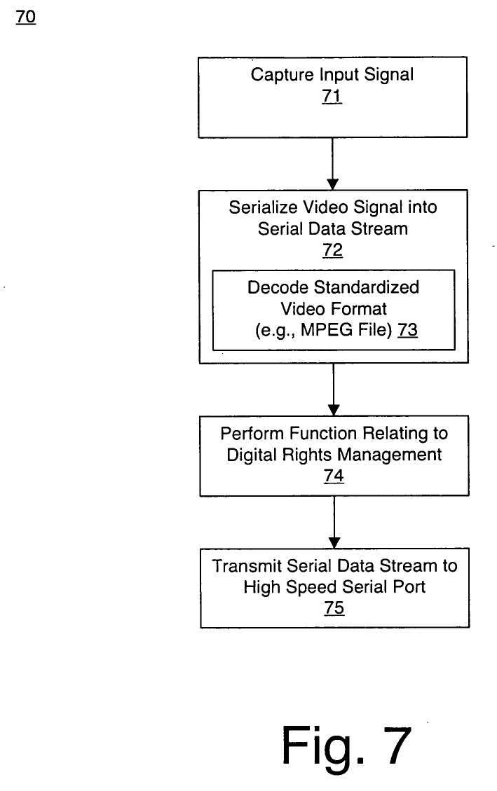

Portions of the detailed description that follows are presented and discussed in terms of a process. Although steps and sequencing thereof are disclosed in a figure herein (e.g., FIG. 7) describing the operations of this process (e.g., process 70), such steps and sequencing are exemplary. Embodiments of the present invention are well suited to performing various other steps or variations of the steps recited in the flowchart of the figure herein, and in a sequence other than that depicted and described herein. In one embodiment, such a process is carried out by processors and electrical and electronic components under the control of computer readable and computer executable instructions comprising code contained in a computer usable medium.

Embodiments of the present invention provide a device, system, and method for bridging a video signal to a high speed serial bus port. In one embodiment, a device for bridging a video signal to a high speed serial bus port has an input for accessing the video signal and a capture component coupled thereto, for capturing the video signal. In one embodiment, the capture component comprises a video tuner. A processing component, coupled to the capture component, processes the video signal. The processing includes serializing the video signal into a serial data stream. A device output, coupled to the processing component, transmits the serial data stream to the high speed serial port, such as a FireWire (IEEE 1394) and/or USB 2.0 port, etc. Thus, the device effectively tunes (e.g., or otherwise captures) a wide variety of video signals and encodes them for transmission on a high speed serial bus.

Therefore, a device, system, and method are provided for bridging a video signal to a high speed serial port that allow a user to access, process, and record a variety of video signals from different video sources, conveniently, inexpensively, and without deterring portability. The device, system, and method for bridging a video signal to a high speed serial bus port disclosed herein provide expandable functionality, which allow the user to simultaneously access, for effectively simultaneous processing and recording, multiple video signals from different video sources.

Exemplary Video Bridging Device

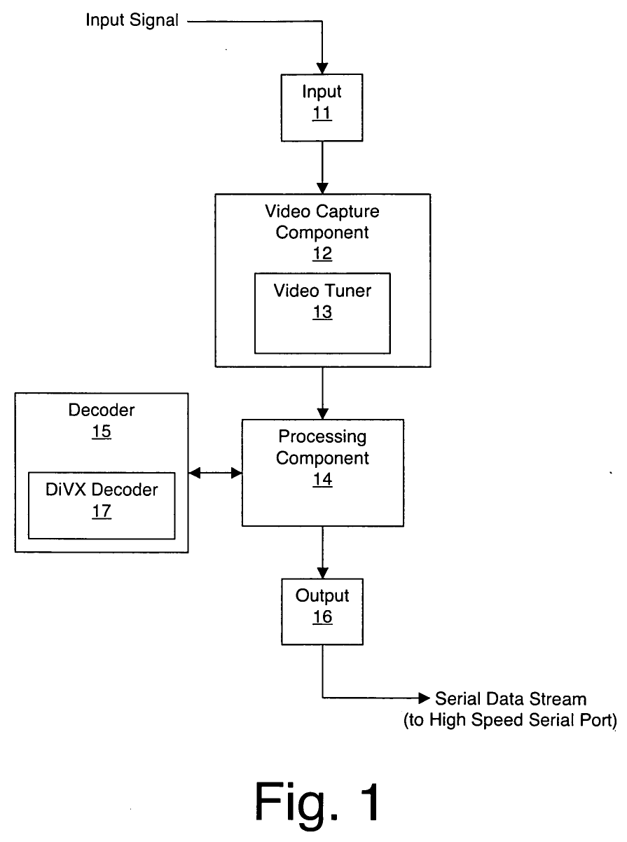

FIG. 1 depicts an exemplary device 10 for bridging an input signal to a high speed serial port, according to an embodiment of the present invention. The input signal is accessed with input 11. As used herein, the input signal can comprise a video signal and related signals, such as an audio signal, an infrared (IR) signal (e.g., from an IR blaster), an audio-video (AN) signal, etc. Video capture component 12 captures the input signal. In one embodiment, video capture component 12 comprises a video tuner 13, which tunes the input signal, e.g., from among other available signals available with input 11.

The captured (e.g., tuned) video signal is then serialized with processing component 14. Processing component serializes the captured video signal into a serial data stream for transmission to a high speed serial port, with output 16. The high speed serial port can accommodate (e.g., electrically couple to and exchange serial data signals with) high speed serial busses, such as FireWire (IEEE 1394), high speed universal serial bus (e.g., USB 2.0), or both.

In one embodiment, processing component 14 functions with (or e.g., includes) a decoder 15, for decoding standardized and/or other video formats, such as Motion Picture Experts Group (MPEG) files, etc. In one embodiment. Decoder 15 includes a decoder functionality 17 for Digital Video Express (DiVX) files. In one embodiment, the file decoder handles MPEG-2 and/or MPEG-4 Files. In one embodiment, the file decoder handles DiVX files. In one embodiment, the file decoder uses Windows media video (WMV9), e.g., with HD-DVD, H.263, AVC/H.264, etc.

Bridging device 10 functions to bridge a variety of video signals to a high speed serial port, e.g., of a computer. In one embodiment, bridging device 10 effectively functions as a “universal” or “legacy,” etc. tuner module with the capability of bridging a number of different video and related signals (e.g., audio signals, infrared signals, etc.) to a high speed serial port. In one embodiment, bridging device 10 effectively functions as a tuner module with the capability of bridging a video signal substantially compliant with the Open Cable Standard to a high speed serial port. In one embodiment, bridging device 10 effectively functions as a digital satellite system (DSS) tuner module with the capability of bridging a DSS signal to a high speed serial port. In one embodiment, bridging device 10 effectively functions as a high definition television (HDTV) tuner module with the capability of bridging a HDTV signal to a high speed serial port. The Input signals to the tuner or other capture device comprise, e.g., various RF signals that are demodulated to MPEG-2/DVB/ATSC/ISDB/etc. transport streams. The streams can be stored for time-shifted playback, e.g., from a system hard drive. The streams can also be trans-coded into more data-rate efficient streams.

One bridging device 10 can function with one or more others, advantageously expanding the functionality available with a single such device. For instance, combining one or more device 10 with one or more other such devices can provide multiple tuner capability.

Exemplary Video Bridging Device Modules

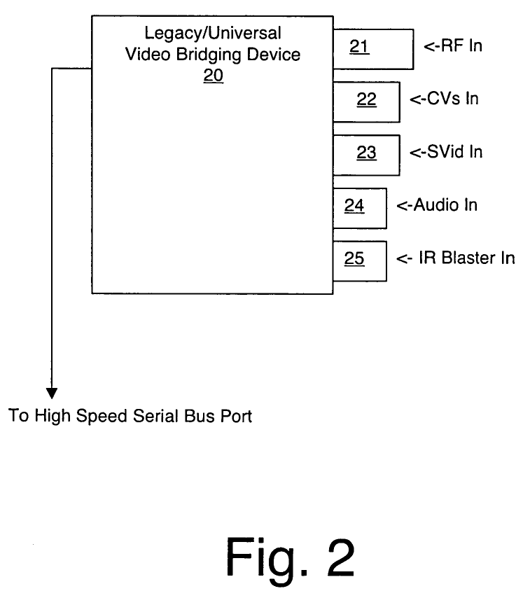

FIG. 2 depicts an exemplary universal/legacy video bridging device module 20, according to an embodiment of the present invention. Bridging device 20 effectively functions as a tuner module with the capability of bridging a number of different audio/video and related signals to a high speed serial port. The input signal to bridging device 20, which effectively provides a the legacy interface is AudioNideo (A/V), and/or an RF connection to a cable-ready tuner therein, or another capture device (e.g., capture component/tuner 12; FIG. 1). This signal can be converted to MPEG-2 (or e.g., another stream, as discussed above) and transferred across the high-speed interface for storage on the processing and data storing apparatus, computer (e.g., PC), etc. A radio frequency (RF) signal may be accessed at input 21. A composite video (CVs) signal may be accessed at input 22. A CVs signals can combine red, green, and blue signals and an audio signal into a single composite signal. A Super Video (Svid) signal may be accessed at input 24. A Svid signal streams chrominance and luminance signals with the same single signal stream. An audio signal may be accessed at input 24. An infrared (IR) signal, e.g., from an IR Blaster, may be accessed at input 25. Universal/legacy bridging device 20 captures and processes these various signals into a serial data stream for transmission to a high speed serial port, such as for FireWire (IEEE 1394), USB 2.0, or both.

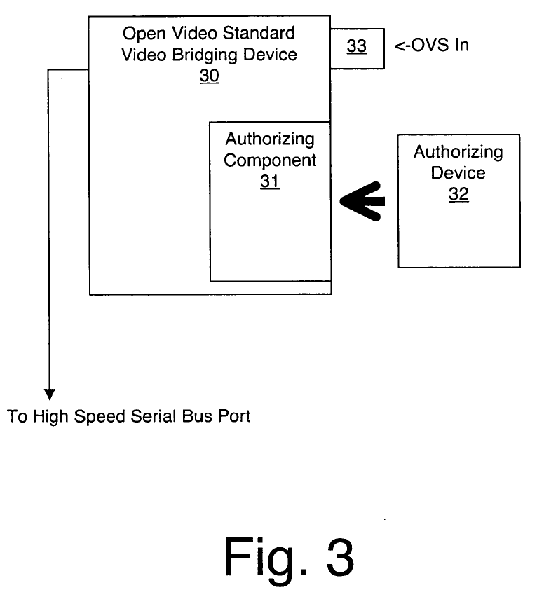

FIG. 3 depicts an exemplary Open Cable Standard (OCS) video bridging device module 30, according to an embodiment of the present invention. Bridging device 30 effectively functions as an OCS tuner module with the capability of bridging an OCS video signal to a high speed serial port. An OCS signal is accessed at input 33. An authorizing component 31, such as a Smart Card reader, scans, reads, senses, etc. an authorizing device 32, such as a Smart Card.

Authorizing component 31, and e.g., authorizing device 32, perform a function related to digital rights management. Bridging device 30, with authorizing component 31, determines that authorizing device 32 is authentic and valid, and that digital rights management functions (e.g., whether a given viewer has the necessary permissions/rights to view a given piece of content) are satisfied. In response, OCS bridging device 30 captures and processes the OCS signal into a serial data stream for transmission to a high speed serial port, such as for FireWire, USB 2.0, or both.

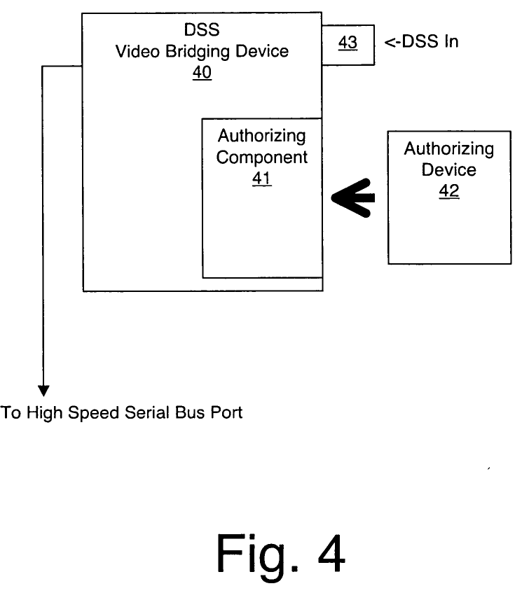

FIG. 4 depicts an exemplary Digital Satellite System (DSS) video bridging device module 40, according to an embodiment of the present invention. Bridging device 40 effectively functions as a DSS tuner module with the capability of bridging a DSS video signal to a high speed serial port. A DSS signal is accessed at input 43. An authorizing component 41, such as a Smart Card reader, scans, reads, senses, etc. an authorizing device 42, such as a Smart Card.

Authorizing component 41, and e.g., authorizing device 42, perform a function related to digital rights management. Where bridging device 40, with authorizing component 41, determines that authorizing device 42 is authentic and valid, and that digital rights management functions are satisfied, OCS bridging device 40 captures and processes the DSS signal into a serial data stream for transmission to a high speed serial port, such as for FireWire, USB 2.0, or both.

One embodiment provides a high definition television (HDTV) video bridging device, which effectively functions as an HDTV tuner module with the capability of bridging an HDTV video signal to a high speed serial port. The function of such an HDTV video bridging device in processing an HDTV signal into a serial data stream for transmission to a high speed serial port is effectively analogous to the function of DSS video bridging device 40 with its DSS signal. Thus, the function of this embodiment can also be understood with reference to this description of the function of video bridging device 40. In one embodiment, such a bridging device bridges signals from a digital visual interface/high definition multimedia interface (DVI/HDMI), a high definition digital versatile disk (HD-DVD), and/or Blu-Ray™, etc.

Exemplary Video Bridging System

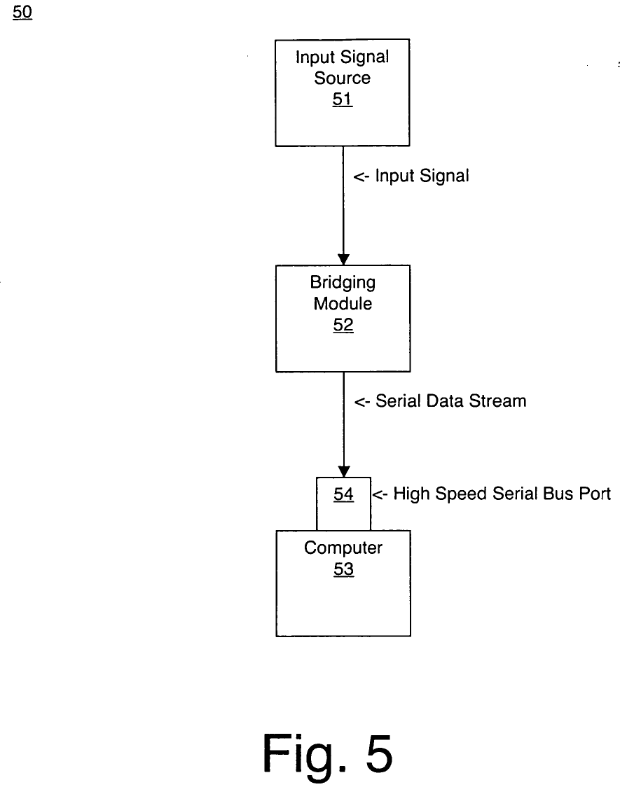

FIG. 5 depicts an exemplary system 50 for bridging a video signal to a high speed serial bus port, according to an embodiment of the present invention. Video signal source 51 outputs a video signal, which is accessed by bridging module 52.

In one embodiment, bridging module 52 comprises a device for bridging a video signal to a high speed serial port (e.g., bridging device 10, FIG. 1). The video signal can comprise an RF signal, a CVs signal, an Svid signal, audio, IR, OCS, DSS, and/or HDTV, etc.

Bridging module 52 captures (e.g., tunes) and processes the video signal into a serial data stream for transmission (e.g., transport with FireWire, a USB 2.0 bus, or both, etc.) to a processing device with storage capabilities, exemplified with computer (e.g., and/or data storage, etc.) 53. Computer 53 accesses the serial data stream with high speed serial port 54. Thus, the serial data stream (e.g., the serialized video stream) can be written directly to a hard drive or other data storage associated with computer 53.

In one embodiment, the processing performed with bridging module 52 also supports decoding of standardized and other video formats, which can comprise MPEG (e.g., MPEG-2 and MPED-4) and DiVX files. In one embodiment, the high speed serial port 54 can accommodate (e.g., electrically couple to and exchange serial data signals with) high speed serial busses, such as FireWire (IEEE 1394), high speed universal serial bus (e.g., USB 2.0), or both.

Bridging system 50 can include one or more other bridging modules, similar in function to bridging module 52, which can each access one or more other input signals from one or more other input signal sources, similar to (e.g., or different from) input signal source 51. Thus, bridging system 50 can provide multiple tuner capability.

Exemplary Expanded Video Bridging System

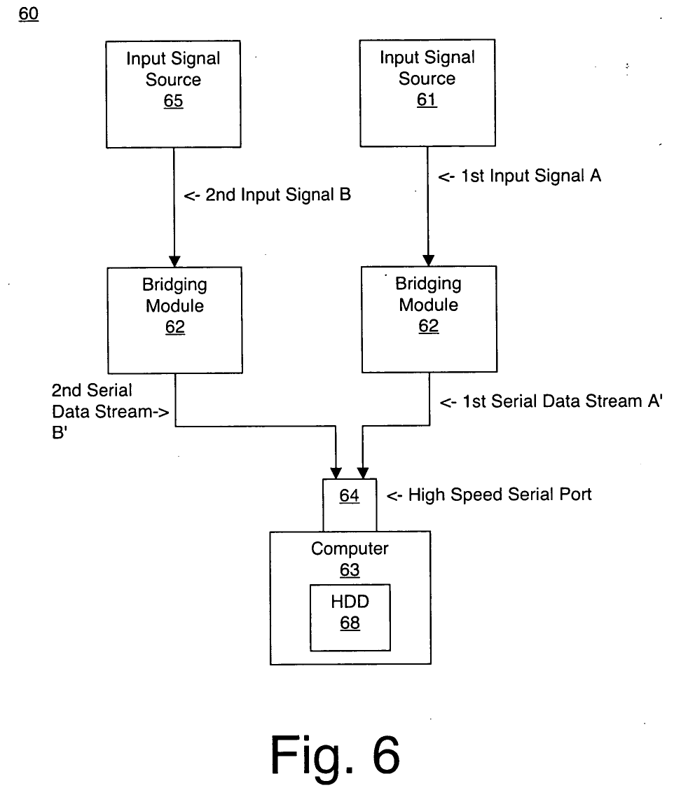

FIG. 6 depicts an exemplary expanded system 60 for bridging an input signal to a high speed serial port, according to an embodiment of the present invention. One Video signal source 61 outputs a first input signal ‘A’, which is accessed by bridging module 62. Another input signal source 65 outputs a second input signal ‘B’, which is accessed by bridging module 66.

In one embodiment, bridging modules 62 and 66 comprise devices for bridging an input signal to a high speed serial port (e.g., bridging device 10; FIG. 1). The input signal can comprise an RF signal, a CVs signal, an Svid signal, audio, IR, OCS, DSS, and/or HDTV, etc.

Bridging modules 62 and 66 respectively tune (e.g., or otherwise captures) and process the input signals A and B into a serial data streams A′ and B′ for transmission to a computer 63. Computer 63 accesses the serial data streams A′ and B′ with high speed serial port 64. Thus, the serial data streams can be written directly to a hard drive or other data storage associated with processing and data storage device 63. Bridging system 60 thus provides multiple tuner capability.

In one embodiment, the processing performed with bridging modules 62 and/or 66 also comprises decoding stadardized video formats, such as MPEG (e.g., MPEG-2 , MPEG-4, etc.) and/or DiVX files, etc. In one embodiment, the high speed serial port 64 can accommodate (e.g., electrically, optically, etc. couple to and exchange serial data signals with) high speed serial busses, such as FireWire (IEEE 1394), high speed universal serial bus (e.g., USB 2.0), or both.

Exemplary Vidio Bridging Process

FIG. 7 is a flowchart of an exemplary process 70 for bridging a video signal to a high speed serial bus port, according to an embodiment of the present invention. Process 70 begins with step 71, wherein one or more input signals are captured, e.g., with a tuner.

In step 72, the input signal is serialized into a serial data stream. Step 72 can include decoding of standardized or other video formats. In step 73, decoding of a standardized or other video formate such as an MPEG file is performed. Decoding the file can comprise decoding DiVX files, MPEG-2 and/or MPEG-4, etc. In one embodiment, decoding is performed with Windows Media Video™ (WMV9™), e.g., with HD-DVD, H.263, AVC/H.264, etc. In one embodiment, a function related to digital rights management is performed in a step 74. In step 75, the serial data stream is transmitted to the high speed serial bus port, completing process 70.

In summary, a device, system, and method provide bridging for a video signal from a video signal source to a high speed serial bus port, such as a FireWire (IEEE 1394) or USB 2.0 port on a computer, data storage device, etc. The device for bridging a video signal to a high speed serial bus port of one embodiment has an input for accessing the video signal and a capture component coupled thereto, for capturing the video signal (e.g., a video broadcast tuner). A processing component, coupled to the capture component, processes the video signal. The processing includes serializing the video signal into a serial data stream.

A device output, coupled to the processing component, transmits the serial data stream to the high speed serial bus port. Thus, the device effectively tunes (e.g., or otherwise captures) a wide variety of video signals and encodes them for transmission on a high speed serial bus. The device can be used with one or more other such devices to provide functional expandability. A system for bridging a video signal to a high speed serial bus port disclosed herein provides such expandable functionality to allow the user to simultaneously access, for effectively simultaneous processing and recording, multiple video signals from different video sources.

Embodiments of the present invention described above thus relate to a device, system, and method for bridging a video signal to a high speed serial bus port. While the present invention has been described in particular exemplary embodiments, the present invention should not be construed as limited by such embodiments, but rather construed according to the following claims and their equivalents.

What is claimed is:

1. A device for bridging an input signal to a high speed serial bus port, comprising:
an input for accessing said input signal;
a capture component coupled to said input, for capturing said input signal;
a processing component coupled to said capture component, for processing said input signal wherein said processing comprises serializing said input signal into a serial data stream; and
an output coupled to said processing component, for transmitting said serial data stream to said high speed serial bus port.

2. The device as recited in claim 1 wherein said input signal comprises one or more of:
a radio frequency signal;
a composite video signal;
a super video signal;
an audio signal; and
an infrared signal.

3. The device as recited in claim 1 wherein said input signal comprises one or more of:
a high definition television signal;
a digital visual interface/high definition multimedia interface signal; and
a high definition digital versatile disk signal.

4. The device as recited in claim 1 wherein said device comprises an authorizing component coupled to said processing component, wherein said authorizing component performs a function related to digital rights management, and wherein said video signal comprises one or more of:
a Digital Satellite System signal; and
a signal that is substantially compliant with an Open Cable Standard.

5. The device as recited in claim 1 wherein said capture component comprises a video tuner.

6. The device as recited in claim 1 wherein said high speed serial bus port comprises a FireWire port.

7. The device as recited in claim 1 wherein said high speed serial bus port comprises a high speed Universal Serial Bus port.

8. The device as recited in claim 1, further comprising a file decoder coupled to said capture component and to said processing component, for decoding one or more of:
a Motion Picture Experts Group file;
a Motion Picture Experts Group-2 file;
a Motion Picture Experts Group-4 file; and
a Windows™ media video file.

9. The device as recited in claim 8, wherein said file decoder decodes a Digital Video Express file.

10. A system for bridging an input signal to a high speed serial port, comprising:
a bridging module coupled to a input signal source, for bridging an input signal to said high speed serial port, wherein said bridging module comprises:
a capture component coupled to an input, for capturing said input signal;
a processing component coupled to said capture component, for processing said input signal wherein said processing comprises serializing said input signal into a serial data stream; and
an output coupled to said processing component, for transmitting said serial data stream to said high speed serial port; and
a device coupled to said output of said bridging module, for accessing said serial data stream, wherein said device comprises said high speed serial port.

11. The system as recited in claim 10 wherein said high speed serial port comprises a FireWire port.

12. The system as recited in claim 10 wherein said high speed serial port comprises a high speed Universal Serial Bus port.

13. The system as recited in claim 10 wherein said bridging module comprises a legacy module for performing said bridging wherein said input signal comprises one or more of:
a radio frequency signal;
a composite video signal;
a super video signal;
an audio signal; and
an infrared signal.

14. The system as recited in claim 10 wherein said bridging module comprises an Open Cable Standard module for performing said bridging wherein said input signal is substantially compliant with an Open Cable Standard and wherein said Open Cable Standard module comprises an authorizing component coupled to said processing component, wherein said authorizing component performs a function related to digital rights management.

15. The system as recited in claim 10 wherein said bridging module comprises a Digital Satellite System module for performing said bridging wherein said input signal comprises a Digital Satellite System signal and wherein said Digital Satellite System bridging module comprises an authorizing component coupled to said processing component, wherein said authorizing component performs a function related to digital rights management.

16. The system as recited in claim 10 wherein said bridging module comprises a high definition television module for performing said bridging wherein said input signal comprises one or more of:
a high definition television signal;
a digital visual interface/high definition multimedia interface signal; and
a high definition digital versatile disk signal.

17. The system as recited in claim 10 wherein said bridging module comprises a plurality of bridging modules, wherein one or more bridging modules of said plurality of bridging modules are combinable with one or more other bridging modules of said plurality of bridging modules, and wherein each said output of each said bridging module of said plurality of bridging modules is transmitted to said high speed serial port.

18. The system as recited in claim 10 wherein said capture component comprises a video tuner.

19. The system as recited in claim 10 wherein said bridging module further comprises a file decoder coupled to said capture component and to said processing component, for decoding one or more of:
a Motion Picture Experts Group file;
a Motion Picture Experts Group-2 file;
a Motion Picture Experts Group-4 file; and
a Windows™ media video file.

20. The system as recited in claim 19 wherein said file decoder further decodes a Digital Video Express file.

21. The system as recited in claim 10 wherein said device coupled to said output of said bridging module comprises a processing device with storage capabilities.

22. A method for bridging an input signal to a high speed serial port, comprising:
capturing said input signal wherein said input signal comprises a plurality of different signals;
serializing said input signal into a serial data stream; and
transmitting said serial data stream to said high speed serial port.

23. The method as recited in claim 22 wherein said capturing comprises tuning.

24. The method as recited in claim 22 wherein said serializing comprises decoding a Motion Pictures Expert Group file.

25. The method as recited in claim 22 wherein said input signal comprises one or more of:
a radio frequency signal;
a composite video signal;
a super video signal;
an audio signal; and
an infrared signal.

26. The method as recited in claim 22 wherein said input signal comprises one or more of:
a high definition television signal;
a digital visual interface/high definition multimedia interface signal; and
a high definition digital versatile disk signal.

27. The method as recited in claim 22 further comprising performing a function related to digital rights management, wherein said input signal comprises one or more of:
a Digital Satellite System signal; and
a signal that substantially complies with an Open Cable Standard.
